(19) United States
(12) Patent Application Publication
(10) Pub. No.: US 2014/0188587 A1
(43) Pub. Date: Jul. 3, 2014

(54) METHOD, SERVER AND SYSTEM OF PROVIDING MEMBERSHIP SERVICE

(71) Applicant: Daum Communications Corp., Jeju-do (KR)

(72) Inventors: Min Cheol KIM, Seoul (KR); Kook Jin KIM, Seoul (KR); Seung Jun OH, Seoul (KR); Mi YU, Seoul (KR); Ji Seung YANG, Seoul (KR); Young Gun KIM, Seoul (KR); Shin Sook KIM, Seoul (KR); Kyoung Goo LEE, Seoul (KR); Dong Young KIM, Seoul (KR); Tae Jin KIM, Seoul (KR); Sung Min KIM, Seoul (KR); Byung Cheol JEON, Seoul (KR)

(21) Appl. No.: 14/142,080

(22) Filed: Dec. 27, 2013

(30) Foreign Application Priority Data
Dec. 27, 2012 (KR) 10-2012-0154209
Sep. 13, 2013 (KR) 10-2013-0110577
Dec. 5, 2013 (KR) 10-2013-0150586

(51) Int. Cl. G06Q 30/02; G06Q 20/20

(52) U.S. Cl. CPC G06Q 30/0226; G06Q 20/20
USPC 705/14.27

(57) ABSTRACT

A method of providing a membership service by a membership service providing server connected with a user terminal, wherein the method includes: a) receiving a membership service subscription request; b) receiving representative card information; c) receiving affiliated company selection information about an affiliated company; d) matching and storing the user information, the affiliated company selection information, and the representative card information; and e) providing the user terminal with at least one of mileage, a stamp, and a coupon provided by the affiliated company when receiving a membership service request through the representative card from an affiliated company server corresponding to the affiliated company selection information.

### CROSS-REFERENCE TO RELATED APPLICATIONS

This application claims priority to and the benefit of Korean Patent Application No. 10-2012-0154209 filed in the Korean Intellectual Property Office on Dec. 27, 2012, and Korean Patent Application No. 10-2013-0110577 filed in the Korean Intellectual Property Office on Sep. 13, 2013, and Korean Patent Application No. 10-2013-0150586 filed in the Korean Intellectual Property Office on Dec. 5, 2013, the entire contents of which are incorporated herein by reference.

### TECHNICAL FIELD

The present invention relates to a method, a server, and a system for providing a membership service, and more particularly, to a method, a server, and a system for providing a membership service, which provide a membership service through a representative card.

### BACKGROUND ART

Recently, as various cards, such as a credit card, a transportation card, a check card, and a cash card, are widely used, the number of users possessing cards, than cash, has been increased. The reason is that when a user possesses cash, such as bills or coins, a thickness or weight of a wallet is increased, so that it is difficult to carry the wallet, and further there is a risk in that the wallet is lost or stolen. Accordingly, users prefer cards which are more convenient to possess than cash, high availability in various companies, and provide various benefits.

However, users become to possess an excessively large number of cards up to card-type identification cards, membership cards issued by various companies, mileage cards, and the like, as well as payment cards, such as credit cards, check cards, and prepaid cards, so that it is inconvenient for the users to hold many cards, and the users are reluctant to carry the cards, except for transportation cards, credit cards, and the like having a high frequency of use. Accordingly, companies issuing membership cards, mileage cards, and the like pay card issuing expenses, but have difficulties in attracting customers, and users also have difficulties in receiving benefits, such as mileage (or point) accumulation, and coupon reception.

Further, credit card companies partially provide services capable of managing memberships, mileages, or the like of various affiliated companies with one card, but even in this case, there is a problem in that it is inconvenient for users to get a separate card, so that users desiring the service are limited, and credit card companies also need to pay card issuing expenses.

### SUMMARY OF THE INVENTION

The present invention has been made in an effort to provide a method of providing a membership service in connection with a registered representative card of a user.

Further, the present invention has been made in an effort to provide a computer readable recoding medium in which a program of executing a method of providing a membership service in connection with a registered representative card of a user is recorded.

Further, the present invention has been made in an effort to provide a server of providing a membership service in connection with a registered representative card of a user.

Further, the present invention has been made in an effort to provide a system of providing a membership service in connection with a registered representative card of a user.

An exemplary embodiment of the present invention provides a method of providing a membership service by a membership service providing server connected with a user terminal includes: a) receiving a membership service subscription request including user information from the user terminal; b) receiving representative card information about a representative card used for the membership service from the user terminal and registering the representative card information; c) receiving affiliated company selection information about an affiliated company, from which the user terminal is to receive the membership service through the representative card, among a plurality of affiliated companies providing the membership service from the user terminal; d) matching and storing the user information, the affiliated company selection information, and the representative card information; and) providing the user terminal according to the user information with at least one of mileage, a stamp, and a coupon provided by the affiliated company when receiving a membership service request through the representative card from an affiliated company server corresponding to the affiliated company selection information.

In this case, in step e) of providing the user terminal according to the user information with at least one of the mileage, the stamp, and the coupon provided by the affiliated company when receiving the membership service request through the representative card from the affiliated company server corresponding to the affiliated company selection information, at least one of the mileage, the stamp, and the coupon of the affiliated company matched with the corresponding representative card information may be saved or a previously saved mileage, stamp, or coupon may be for payment when making the payment by using the representative card.

Further, step b) may include: receiving the representative card information from the user terminal; receiving whether the representative card information is valid from a card company server corresponding to the representative card information; and determining whether to register the representative card according to whether the representative card information is valid.

Further, step c) may include: receiving affiliated company membership information for joining the affiliated company corresponding to the affiliated company selection information as a member from the user terminal; and transmitting the affiliated company membership information to the affiliated company server.

Further, the method may further include providing the user terminal with changed matter information about the mileage, the stamp, or the coupon when a changed matter is generated in at least one of the mileage, the stamp, and the coupon provided to the user terminal.

Further, the method may further include: receiving a use detail information transmission request of the mileage, the stamp, or the coupon from the user terminal; and providing the user terminal with use detail information about the mileage, the stamp, or the coupon of a user corresponding to the user information.

In the meantime, the method may further include providing another user terminal with at least a part of the mileage, the stamp, and the coupon received by the user terminal according to a request of the user terminal.

Further, the method may further include converting at least a part of mileage, a stamp, and a coupon of a predetermined affiliated company received by the user terminal into mileage, a stamp, or a coupon of another affiliated company according to a request of the user terminal.

Further, the method may further include converting at least a part of mileage of a predetermined affiliated company received by the user terminal into a stamp or a coupon and saving the converted stamp or coupon according to a request of the user terminal, converting a stamp of a predetermined affiliated company received by the user terminal into mileage or a coupon and saving the converted mileage or coupon according to a request of the user terminal, or converting a coupon of a predetermined affiliated company received by the user terminal into mileage or a stamp and saving the converted mileage or stamp according to a request of the user terminal.

Further, the method may further include providing the user terminal with mileage, a stamp, or a coupon corresponding to registered information when the user terminal registers information, which is obtained from at least one of a barcode, a QR code, a serial number, and an RFID printed or attached onto a product, in the membership service providing server.

Further, the method may further include saving at least a part of mileage, a stamp, and a coupon provided by a predetermined affiliated company according to a predetermined activity of a user's SNS account which is previously registered in connection with the user information.

Another exemplary embodiment of the present invention provides a method of providing a membership service, including: adding, by a franchise POS terminal, an advertisement code (AD code) to a sound source and outputting the sound source as sound waves through a speaker; detecting, by a user terminal, the output sound waves and recognizing the AD code in the detected sound waves; recognizing, by the user terminal, affiliated company selection information in connection with a corresponding franchise through the recognized AD code, and determining whether the recognized affiliated company selection information is registered; in a case where the recognized affiliated company selection information is not registered as a result of the determination, requesting, by the user terminal, the affiliated company selection information from a membership service providing server and receiving the requested affiliated company selection information, matching the received affiliated company selection information with user information and representative card information and registering the matched information, and saving at least one of mileage, a stamp, and a coupon of a corresponding affiliated company through a membership service request with a representative card; and in a case where the recognized affiliated company selection information is registered, requesting, by the user terminal, at least one of mileage, a stamp, and a coupon of a corresponding affiliated company provided through the AD code from the membership service providing server and receiving at least one of the mileage, the stamp, and the coupon of the corresponding affiliated company, and saving the received mileage, stamp, or coupon, or using at least one of the saved mileage, stamp, and coupon for payment with the representative card.

Another exemplary embodiment of the present invention provides a method of providing a membership service by a membership service providing server connected with a user terminal, the method including: a) receiving a membership service subscription request including user information from the user terminal; b) receiving representative card information about a representative card used for the membership service from the user terminal and registering the representative card information; c) receiving affiliated company selection information about an affiliated company, from which the user terminal is to receive the membership service through the representative card, among a plurality of affiliated companies providing the membership service, from the user terminal; d) matching and storing the user information, the affiliated company selection information, and the representative card information; and e) when receiving a membership service request through the representative card from an affiliated company server corresponding to the affiliated company selection information, providing a user according to the user information with at least one of mileage, a stamp, and a coupon provided by the affiliated company, in which the number of representative cards is plural.

Here, step d) may include batching and matching the user information, affiliated company information according to the affiliated company selection information, and information about the plurality of representative cards and storing the matched information.

Further, step e) may include: when receiving a membership service request through any one representative card among the plurality of representative cards from the affiliated company server, confirming whether the representative card requesting the membership service is matched with an affiliated company corresponding to the affiliated company server; and providing the user with at least one of mileage, a stamp, and a coupon provided by the affiliated company when the representative card requesting the membership service is matched with the affiliated company as a result of the confirmation.

Further, the providing of the user with at least one of the mileage, the stamp, and the coupon provided by the affiliated company when the representative card requesting the membership service is matched with the affiliated company as a result of the confirmation may include saving at least one of the mileage, the stamp, and the coupon of the affiliated company matched with information about the corresponding representative card, or using a previously saved mileage, stamp, or coupon for a payment when making the payment using the representative card.

Further, in the batching and matching of the affiliated company information according to the affiliated company selection information with the information about the plurality of representative cards and storing the matched information, when a single affiliated company matched with only one representative card is included in affiliated companies according to the affiliated company selection information, information about the single affiliated company may be matched with the user information and representative card information about any one representative card among the plurality of representative cards.

Further, any one of the plurality of representative cards may be determined according to main representative card selection information received through the user terminal.

In the meantime, the method may further include providing another user terminal with at least a part of the mileage, the stamp, and the coupon received by the user terminal according to a request of the user terminal.

Further, the method may further include converting at least a part of mileage, a stamp, and a coupon of a predetermined affiliated company received by the user terminal into mileage, a stamp, or a coupon of another affiliated company according to a request of the user terminal.

Further, the method may further include converting at least a part of mileage of a predetermined affiliated company received by the user terminal into a stamp or a coupon and saving the converted stamp or coupon according to a request of the user terminal, converting a stamp of a predetermined affiliated company received by the user terminal into mileage or a coupon and saving the converted mileage or coupon according to a request of the user terminal, or converting a coupon of a predetermined affiliated company received by the user terminal into mileage or a stamp and saving the converted mileage or stamp according to a request of the user terminal.

Further, the method may further include providing the user terminal with mileage, a stamp, or a coupon corresponding to registered information when the user terminal registers information obtained from at least one of a barcode, a QR code, a serial number, and an RFID printed or attached onto a product, in the membership service providing server.

Further, the method may further include saving at least a part of mileage, a stamp, and a coupon provided by a predetermined affiliated company according to a predetermined activity of a user's SNS account which is previously registered in connection with the user information.

Another exemplary embodiment of the present invention provides a method of providing a membership service, including: adding, by a franchise POS terminal, an advertisement code (AD code) to a sound source and outputting the sound source as sound waves through a speaker; detecting, by a user terminal, the output sound waves and recognizing the AD code in the detected sound waves; recognizing, by the user terminal, affiliated company selection information in connection with a corresponding franchise through the recognized AD code, and determining whether the recognized affiliated company selection information is registered; in a case where the recognized affiliated company selection information is not registered as a result of the determining as a result of the determination, requesting, by the user terminal, the affiliated company selection information from a membership service providing server and receiving the requested affiliated company selection information, matching the received affiliated company selection information with user information and representative card information and registering the matched information, and saving at least one of mileage, a stamp, and a coupon of a corresponding affiliated company through a membership service request with a representative card; and in a case where the recognized affiliated company selection information is registered, requesting, by the user terminal, at least one of mileage, a stamp, and a coupon of a corresponding affiliated company provided through the AD code from the membership service providing server and receiving at least one of the mileage, the stamp, and the coupon of the corresponding affiliated company, and saving the received mileage, stamp, or coupon, or using at least one of a saved mileage, stamp, and coupon for payment with the representative card, in which the number of representative cards is plural.

Another exemplary embodiment of the present invention provides a computer readable recoding medium in which a program for executing the method of providing the membership service is recorded.

Another exemplary embodiment of the present invention provides a membership service providing server, which is connected with a user terminal to provide a membership service, the server including: a membership service subscription request receiving unit configured to receive a membership service subscription request including user information from the user terminal; a representative card information registering unit configured to receive representative card information about a representative card used for the membership service from the user terminal and register the representative card information; an affiliated company selection information receiving unit configured to receive affiliated company selection information about an affiliated company, from which the user terminal is to receive the membership service through the representative card, among a plurality of affiliated companies providing the membership service from the user terminal; a storing unit configured to match and store the user information, the affiliated company selection information, and the representative card information; and a membership service providing unit configured to provide the user terminal according to the user information with at least one of mileage, a stamp, and a coupon provided by the affiliated company when receiving a membership service request through the representative card from an affiliated company server corresponding to the affiliated company selection information, in which the membership service providing unit saves at least one of the mileage, the stamp, and the coupon of the affiliated company matched with the corresponding representative card information, or uses a previously saved mileage, stamp, or coupon for a payment when making the payment using the representative card.

Here, the representative card information registering unit may include: a representative card information validity confirming unit configured to receive whether the representative card information is valid from a card company server corresponding to the representative card information when receiving the representative card information; and a representative card registration determining unit configured to determine whether to register the representative card according to whether the representative card information is valid.

Further, the affiliated company selection information receiving unit may further include an affiliated company membership information transceiving unit configured to receive affiliated company membership information for joining the affiliated company corresponding to the affiliated company selection information as a member from the user terminal, and transmit the affiliated company membership information to the affiliated company server.

Further, the membership service providing unit may include a changed matter information providing unit configured to provide the user terminal with changed matter information about the mileage, the stamp, or the coupon when a changed matter is generated in at least one of the mileage, the stamp, and the coupon provided to the user.

Further, the membership service providing unit may include a use detail information providing unit configured to provide to the user terminal with use detail information about the mileage, the stamp, or the coupon of a user corresponding to the user information when receiving a use detail information transmission request of the mileage, the stamp, or the coupon from the user terminal.

In the meantime, the membership service providing unit may provide another user terminal with at least a part of the mileage, the stamp, and the coupon received by the user terminal according to a request of the user terminal.

Further, the membership service providing unit may convert at least a part of the mileage, the stamp, and the coupon of a predetermined affiliated company received by the user terminal into mileage, a stamp, or a coupon of another affiliated company according to a request of the user terminal.

Further, the membership service providing unit may convert at least a part of mileage of a predetermined affiliated company received by the user terminal into a stamp or a coupon and saves the converted stamp or coupon according to a request of the user terminal, convert a stamp of a predetermined affiliated company received by the user terminal into mileage or a coupon and save the converted mileage or coupon according to a request of the user terminal, or convert a coupon of a predetermined affiliated company received by the user terminal into mileage or a stamp and save the converted mileage or stamp according to a request of the user terminal.

Further, the membership service providing unit may provide the user terminal with mileage, a stamp, or a coupon corresponding to registered information according to a request of the user terminal when information obtained from at least one of a barcode, a QR code, a serial number, and an RFID printed or attached onto a product is registered.

Further, the membership service providing unit may save at least a part of mileage, a stamp, and a coupon provided by a predetermined affiliated company according to a predetermined activity of a user's SNS account which is previously registered in connection with the user information.

Another exemplary embodiment of the present invention provides a membership service providing server, which is connected with a user terminal to provide a membership service, the server including: a membership service subscription request receiving unit configured to receive a membership service subscription request including user information from the user terminal; a representative card information registering unit configured to receive representative card information about a representative card used for the membership service from the user terminal and register the representative card information; an affiliated company selection information receiving unit configured to receive affiliated company selection information about an affiliated company, from which the user terminal is to receive the membership service through the representative card, among a plurality of affiliated companies providing the membership service from the user terminal; a storing unit configured to match and store the user information, the affiliated company selection information, and the representative card information; and a membership service providing unit configured to provide the user terminal according to the user information with at least one of mileage, a stamp, and a coupon provided by the affiliated company when receiving a membership service request through the representative card from an affiliated company server corresponding to the affiliated company selection information, in which the number of representative cards is plural.

Further, the storing unit may batch and match the user information, affiliated company information according to the affiliated company selection information, and information about the plurality of representative cards and store the matched information.

Further, when the membership service providing unit receives a membership service request through any one representative card among the plurality of representative cards from the affiliated company server, the membership service providing unit may confirm whether the representative card requesting the membership service is matched with an affiliated company corresponding to the affiliated company server, and when the representative card requesting the membership service is matched with the affiliated company as a result of the confirmation, the membership service providing unit may provide the user terminal with at least one of mileage, a stamp, and a coupon provided by the affiliated company.

Further, the membership service providing unit may save at least one of the mileage, the stamp, and the coupon of the affiliated company matched with the corresponding representative card information, or use a previously saved mileage, stamp, or coupon for a payment when making the payment using the representative card.

Further, when a single affiliated company matched with only one representative card is included in affiliated companies according to the affiliated company selection information, the storing unit may match information about the single affiliated company with the user information and representative card information about any one representative card among the plurality of representative cards.

Further, the storing unit may determine any one of the plurality of representative cards matched with the single affiliated company according to main representative card selection information received through the user terminal.

In the meantime, the membership service providing unit may provide another user terminal with at least a part of the mileage, the stamp, and the coupon received by the user terminal according to a request of the user terminal.

Further, the membership service providing unit may convert at least a part of mileage, a stamp, and a coupon of a predetermined affiliated company received by the user terminal into mileage, a stamp, or a coupon of another affiliated company according to a request of the user terminal.

Further, the membership service providing unit may convert at least a part of mileage of a predetermined affiliated company received by the user terminal into a stamp or a coupon and saves the converted stamp or coupon according to a request of the user terminal, convert at least of a stamp of a predetermined affiliated company received by the user terminal into mileage or a coupon and save the converted mileage or coupon according to a request of the user terminal, or convert a coupon of a predetermined affiliated company received by the user terminal into mileage or a stamp and save the converted mileage or stamp according to a request of the user terminal.

Further, the membership service providing unit may provide the user terminal with mileage, a stamp, or a coupon corresponding to registered information according to a request of the user terminal when information obtained from at least one of a barcode, a QR code, a serial number, and an RFID printed or attached onto a product is registered, which may be applied to a product provided by a manufacturing company which does not provide a membership, as well as a product of a manufacturing company which provides a membership. However, in a case of the product provided by the manufacturing company which does not provide the membership, mileage and the like may be saved only when the user directly registers information about the barcode and the like printed or attached onto the product.

Further, the membership service providing unit may save saves at least a part of mileage, a stamp, and a coupon provided by a predetermined affiliated company according to a predetermined activity of a user's SNS account which may be previously registered in connection with the user information.

Another exemplary embodiment of the present invention provides a system for providing a membership service, including: a membership service providing server configured to provide mileage, a stamp, or a coupon of affiliated company selection information matched with pre-registered representative card information for each user; a franchise POS terminal configured to add an advertisement code (AD code) to a sound source and output the sound source as sound waves through a speaker; and a user terminal configured to detect the output sound waves and recognize the AD code in the detected sound waves, request mileage, a stamp, or a coupon of affiliated company selection information in connection with a corresponding franchise from a membership service providing server through the recognized AD code, receive and save the mileage, the stamp, or the coupon, and use the saved mileage, stamp, or coupon when making a payment using a stored representative card which is matched with the affiliated company selection information in advance.

In this case, the user terminal may determine whether corresponding affiliated company selection information is stored through the recognized AD code, and when the corresponding affiliated company selection information is not stored as a result of the determination, the user terminal may request the affiliated company selection information from the membership service providing server and receive the requested affiliated company selection information, and match the received affiliated company selection information with the representative card information and store the matched information. In this case, the user terminal may display the affiliated company selection information on a screen in a form of an SMS, a push message, and a pop-up, and the like. Further, the membership service providing server may transmit the affiliated company selection information to the user terminal according to the request of the affiliated company selection information.

Another exemplary embodiment of the present invention provides a system for providing a membership service, including: a membership service providing server configured to provide mileage, a stamp, or a coupon of affiliated company selection information matched with pre-registered representative card information for each user; a franchise POS terminal configured to add an advertisement code (AD code) to a sound source and output the sound source as sound waves through a speaker; and a user terminal configured to detect the output sound waves and recognize the AD code in the detected sound waves, request mileage, a stamp, or a coupon of affiliated company selection information in connection with a corresponding franchise from a membership service providing server through the recognized AD code, receive and save the mileage, the stamp, or the coupon, and use the saved mileage, stamp, or coupon when making a payment using a stored representative card which is matched with the affiliated company selection information in advance, in which the number of representative cards is plural.

In this case, the user terminal may determine whether corresponding affiliated company selection information is stored through the recognized AD code, and when the corresponding affiliated company selection information is not stored as a result of the determination, the user terminal may request the affiliated company selection information to the membership service providing server and receive the requested affiliated company selection information, and match the received affiliated company selection information with the representative card information and store the matched information.

Further, the membership service providing server may transmit the affiliated company selection information to the user terminal according to a request of the affiliated company selection information.

According to exemplary embodiments of the present invention, a user registers a representative card among his/her possessed cards and receives a membership service by using the registered representative card, so that the user does not need to be issued with a separate card, thereby reducing a card issuing expense.

According to exemplary embodiments of the present invention, it is possible to simply batch and match a plurality of elements of representative card information with one or more affiliated company selection information and register the matched information without a complicated procedure in which a user matches the plurality of representative cards with affiliated companies one by one and registers the matched information, thereby improving convenience for the user.

Further, according to exemplary embodiments of the present invention, it is possible to provide a user terminal with affiliated company information about a franchise by using an AD code and save and use mileage, a stamp, a coupon, and the like of the affiliated company available at the corresponding franchise by using information about the AD code. Further, it is possible to provide guide information, such as interest-free installment, discount, and free saving, by using the AD code, and induce a user to participate in an event by providing information about various promotions.

Further, it is possible for a user terminal receiving an AD code to transmit the AD code to another user terminal, and provide a settlement discount by the number of times of phone-to-phone transception/approval of the AD code, thereby providing various elements of information.

It should be understood that the effects of the present invention are not limited to the aforementioned effects, and include all of the effects deducible from the detailed description of the present invention or the configuration of the invention described in the claims.

### BRIEF DESCRIPTION OF THE DRAWINGS

FIG. 1 is a diagram illustrating a configuration of a membership service providing system according to an exemplary embodiment of the present invention.

FIG. 2 is a diagram illustrating a configuration of a membership service providing server according to the exemplary embodiment of the present invention.

FIG. 3 is a flowchart illustrating a membership service providing method according to another exemplary embodiment of the present invention.

### DETAILED DESCRIPTION

The present invention may be variously modified and have various exemplary embodiments, so that specific exemplary embodiments will be illustrated in the drawings and described in detail in the detailed description to carry out the invention. However, this is not intended to limit the present invention to the specific exemplary embodiments, and it will be appreciated that the present invention includes all modifications, equivalences, or substitutions included in the spirit and the technical scope of the present invention. In the description of respective drawings, similar reference numerals designate similar elements.

Terms “first”, “second”, “A”, “B”, and the like may be used for describing various constituent elements, but the constituent elements should not be limited to the terms. The terms are used only to discriminate one constituent element from another constituent element. For example, without departing from the scope of the invention, a first constituent element may be named a second constituent element, and similarly a second constituent element may be named a first constituent element. A term “and/or” includes a combination of multiple relevant described items or any one of the multiple relevant described items.

It should be understood that when one constituent element is referred to as being “coupled to” or “connected to” another constituent element, the one constituent element can be directly coupled to or connected to the another constituent element, but intervening elements may also be present therebetween. In contrast, when one constituent element is “directly coupled to” or “directly connected to” another constituent element, it should be understood that there is no intervening element therebetween.

Terms used in the present application are used only to describe specific exemplary embodiments, and are not intended to limit the present invention. Singular expressions used herein include plurals expressions unless the singular expressions have definitely opposite meanings. In the present invention, it should be understood that term “include” or have indicates that a feature, a number, a step, an operation, a component, a part or a combination thereof described in the specification is present, but does not exclude a possibility of presence or addition of one or more other features, numbers, steps, operations, components, parts or combinations thereof, in advance.

All terms used herein including technical or scientific terms have the same meanings as meanings which are generally understood by those skilled in the art unless otherwise defined. Terms defined in generally used dictionary shall be construed to have meanings matching those in the context of a related art, and shall not be construed as ideal or excessively formal meanings unless clearly defined in the present application.

Hereinafter, exemplary embodiments according to the present invention will be described in detail with reference to the accompanying drawings.

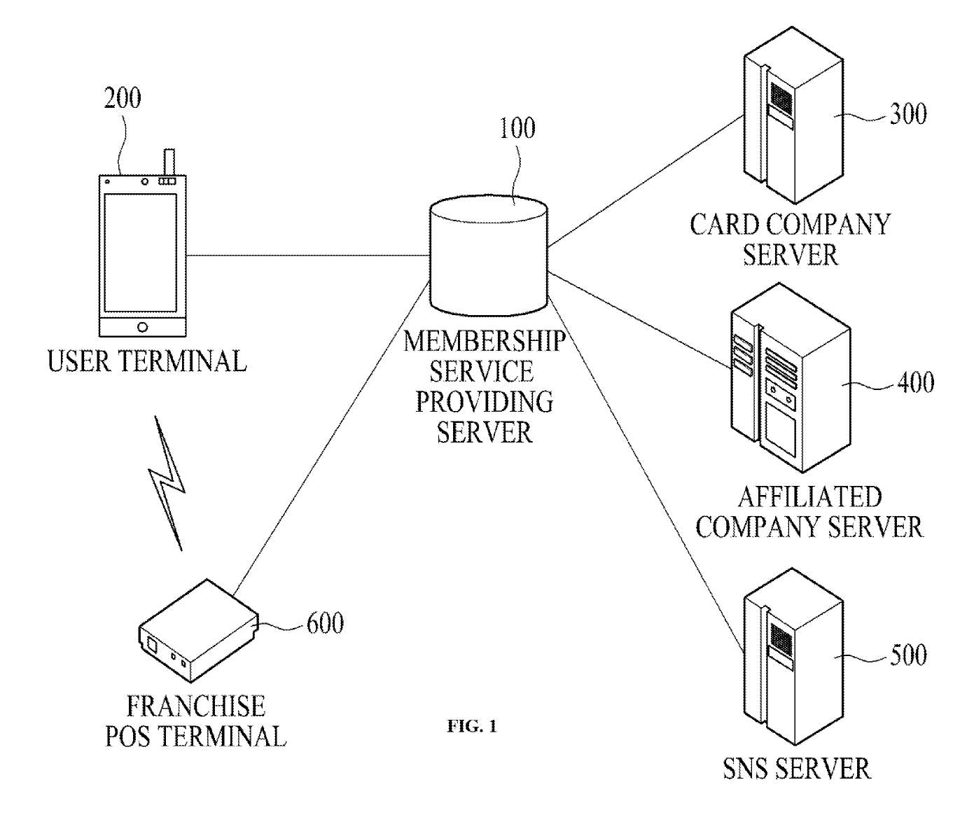

FIG. 1 is a diagram illustrating a configuration of a membership service providing system according to an exemplary embodiment of the present invention.

Referring to FIG. 1, the membership service providing system according to the exemplary embodiment of the present invention includes a membership service providing server 100, a user terminal 200, a card company server 300, an affiliated company server 400, an SNS server 500, and a franchise POS terminal 600.

The user terminal 200 transmits a membership service subscription request including user information to the membership service providing server 100. In this case, the user terminal 200 may be implemented by a computer or a portable terminal connectable with the membership service providing server 100, which is a server of a remote place, through a network. Here, the computer may include, for example, a notebook computer, a desktop computer, and a laptop computer in which a WEB browser is installed, and the portable terminal may be, for example, a wireless communication apparatus securing portability and mobility and include every type of handheld-based wireless communication apparatus, such as a personal communication system (PCS), a global system for mobile communications (GSM), a personal digital cellular (PDC), a personal handyphone system (PHS), a personal digital assistant (PDA), an international mobile telecommunication (IMT)-2000 terminal, a code division multiple access (CDMA)-2000 terminal, a W-code division multiple access (W-CDMA) terminal, a wireless broadband Internet (Wibro) terminal, and a smart phone.

When the membership service providing server 100 receives the membership service subscription request including the user information, a membership service subscription procedure may be started.

The user terminal 200 transmits representative card information about a representative card to be used for the membership service to the membership service providing server 100, and the representative card, which is a card for using the membership service, may be any one among cards possessed by the user.

In this case, the representative card may include one of a credit card, a check card, a prepaid card, a cash card, a membership card, and mileage card. For example, the user may select a most frequently used card among his/her already possessed cards as the representative card, and transmit information about the representative card to the membership service providing server 100 through the user terminal 200.

Hereinafter, the representative card in the present specification means a representative card registered by the user in order to receive membership services provided by a plurality of matched affiliated companies.

According to the exemplary embodiment, the number of representative cards may be plural, and in a case where the number of representative cards selected for receiving the membership services by the user is plural, the user terminal 200 may transmit and register a plurality of elements of representative card information to the membership service providing server 100.

The membership service providing server 100 may transmit the representative card information about the representative cards used for the membership service to the card company server 300 to confirm whether the representative card information is valid, and register the cards selected as the representative cards by the user as the representative cards for providing the membership service according to a result of the confirmation.

In this case, when the number of representative cards selected by the user is plural as described above, the membership service providing server 100 may receive the information about the plurality of cards as the representative card information, and the plurality of representative cards may be registered according to a result of confirming whether each card information received from the card company server 300 corresponding to the representative card information is valid.

When invalid card information is included in the plurality of elements of the representative card information, a corresponding card may not be registered as the representative card, and an error message for the corresponding card may be transmitted to the user terminal 200.

Whether the representative card information is valid may be determined by the card company server 300 corresponding to the representative card information. The card company server 300 may determine whether the representative card information is valid by using a unique card number, card company information, a CVC number, and the like, which are included in the representative card information, and transmit a result of the determination to the membership service providing server 100.

The user terminal 200 may select an affiliated company, from which the user is to receive the membership service through the representative card, among a plurality of affiliated companies providing the membership service, and transmit affiliated company selection information to the membership service providing server 100. For example, in a case where the number of affiliated companies, which the user desires to use, among the plurality of affiliated companies providing the membership service is five, the affiliated company selection information may be transmitted to the membership service providing server 100 through the process of selecting the corresponding five affiliated companies by the user terminal 200.

In this case, the affiliated company selection information may include affiliated company membership information for joining the corresponding affiliated company as a member, and the membership service providing server 100 may transmit the affiliated company membership information to the affiliated company server 400 of the affiliated company and perform a member joining procedure of the corresponding affiliated company together.

When the membership service providing server 100 receives the affiliated company selection information about the affiliated company, from which the user terminal is to receive the membership service, the membership service providing server 100 matches the user information, the affiliated company selection information and the representative card information and stores the matched user information, affiliated company selection information and representative card information.

In this case, when the user has registered the plurality of representative cards in the membership service providing server 100, the membership service providing server 100 may match the plurality of registered representative cards with the affiliated company to receive the membership service and store the matched plurality of registered representative cards and affiliated company to receive the membership service.

The membership service providing server 100 may batch and match one or more elements of affiliated company information included in the user information and the affiliated company selection information, with the plurality of elements of the representative card information. Then, matching result information in which the user information, the affiliated company selection information, and the representative card information are matched may be transmitted to the user terminal.

For example, in a case where affiliated companies registered by user KAB are affiliated companies A, B, and C, and the representative cards are representative cards Ka, Na, Da, and Ra, affiliated companies A, B, and C may be matched with representative cards Ka, Na, Da, and Ra. That is, affiliated company A may be batched and matched with representative cards Ka, Na, Da, and Ra, affiliated company B may be batched and matched with representative cards Ka, Na, Da, and Ra, and affiliated company C may be batched and matched with representative cards Ka, Na, Da, and Ra to be stored.

In the meantime, in a case where a single affiliated company matched with only one representative card is included among the affiliated companies according to the affiliation company selection selected by the user so as to receive the membership service, the single affiliated company may be matched with any one representative card (for example, a main representative card) only among the plurality of registered representative cards.

In the meantime, when the membership service providing server 100 receives a membership service request using the representative card from the affiliated company server corresponding to the affiliated company selection information, the membership service providing server 100 provides the corresponding user with the membership service, that is, at least one of mileage, a stamp, and a coupon of the corresponding affiliated company. At least one of the provided mileage, stamp, and coupon may be saved for each user, and then the saved mileage, stamp, or coupon may be used at the corresponding affiliated company by the user.

Here, payment using the representative card may adopt a method of scratching a magnetic line of a payment card in a card reader to make a payment, and in addition, may adopt a payment method by a near field wireless communication (NFC) manner using an NFC tag as a matter of course. Further, the payment using the representative card may also adopt an online payment method through the Internet and the like by using the representative card, and the payment method in the present invention is not limited.

When the user desires to receive the membership service by using the representative card at the affiliated company corresponding to the affiliated company selection information, the membership service request may be transmitted to the membership service providing server 100 from the affiliated company server 400. In this case, the membership service request may include a payment request using the representative card at the affiliated company, but is not limited thereto.

Then, the user terminal 200 may access the membership service providing server 100 to confirm the details of mileages, stamps, or coupons, which are saved for the user, and the details of used mileages, stamps, or coupons.

The franchise POS terminal 600 may be configured to designate a sound source output through a speaker at the franchise. The franchise POS terminal 600 may be configured to add a predetermined advertisement (AD) code to the sound source and output the sound source by sound waves through the speaker.

Because the sound waves may not pass through a wall, it is possible to receive electric waves only within the franchise, and the AD code added to the sound waves is not recognized by users.

The AD code is configured so that the user terminal 200 may request the affiliated company selection information and at least one of the mileage, the stamp, and the coupon of the affiliated company selection information from the membership service providing server 100.

The user terminal 200 detects the sound waves of the speaker and recognizes the AD code in the detected sound waves. An application for recognizing the AD code and implementing a corresponding operation may be included in the user terminal 200 in advance.

The user terminal 200 may be configured to recognize the affiliated company selection information in connection with a corresponding franchise through the recognized AD code, and determines whether the recognized affiliated company selection information is already registered in the user terminal 200.

As a result of the determination, when the recognized affiliated company selection information is not registered, the user terminal 200 may be configured to request the affiliated company selection information from the membership service providing server 100 and receive the requested affiliated company selection information from the membership service providing server 100, and match the received affiliated company selection information with the user information and the representative card information and register the matched affiliated company selection information.

Further, the user terminal 200 may be configured to save at least one of the mileage, the stamp, and the coupon of the corresponding affiliated company through the membership service request through the representative card.

In the meantime, as the result of the determination, when the recognized affiliated company selection information is registered, the user terminal 200 may be configured to as to request at least one of the mileage, the stamp, and the coupon of the corresponding affiliated company provided through the AD code to the membership service providing server 100 and receive the requested one from the membership service providing server 100.

Further, the user terminal 200 may be configured to save the received mileage, stamp, or coupon, or use at least one of the saved mileage, stamp, and coupon for the payment through the representative card.

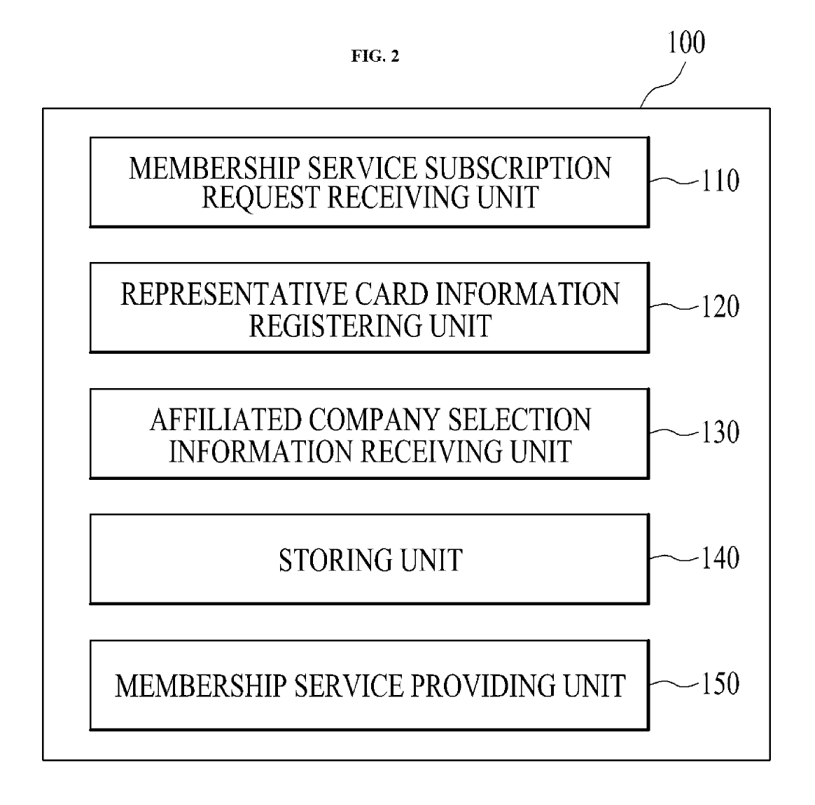

FIG. 2 is a diagram illustrating a configuration of the membership service providing server according to the exemplary embodiment of the present invention.

Referring to FIG. 2, the membership service providing server 100 according to the exemplary embodiment of the present invention includes a membership service subscription request receiving unit 110, a representative card information registering unit 120, an affiliated company selection information receiving unit 130, a storing unit 140, and a membership service providing unit 150.

The membership service subscription request receiving unit 110 receives a membership service subscription request including user information from a user terminal.

The representative card information registering unit 120 receives representative card information of a representative card to be used for the membership service from the user terminal and registers the representative card information. As described above, the representative card is a card for using the membership service, and at least one of cards possessed by the user may be designated and registered as the representative card. Here, when the number of cards designated as the representative cards by the user is plural, information about the plurality of designated cards may be registered as the representative card information.

In this case, the representative card information may include a unique card number, card company information, a CVC number, and the like of the card. For example, the user selects a plurality of cards among his/her possessed cards and inputs card numbers of 16 digits, card company information, and CVC information of the corresponding cards in order to register the selected cards as the representative card, so that the representative card information may be transmitted to the representative card information registering unit 120.

The representative card information registering unit 120 may receive selection information about a card to be used as a main representative card among the plurality of representative cards from the user terminal and store main representative card selection information together with the representative card information.

The representative card information registering unit 120 may include a representative card information validity confirming unit (not illustrated) and a representative card registration determining unit (not illustrated).

When the representative card information validity confirming unit receives the representative card information from the user terminal, the representative card information validity confirming unit may transmit a confirmation request for validity of the representative card information to a card company server (not illustrated) corresponding to the representative card information and receive whether the representative card information is valid from the card company server. In this case, when the number of elements of the received representative card information is plural, the representative card information validity confirming unit may receive whether each representative card information is valid from each of the card company servers corresponding to the plurality of elements of the received representative card information.

The representative card registration determining unit 120 may determine whether to register the representative card according to whether the representative card information is valid.

When the representative card information transmitted by the user terminal is valid according to a result of the confirmation of the validity of the representative card information transmitted from the card company server, the representative card registration determining unit 120 may register the card corresponding to the representative card information transmitted by the user terminal as the representative card, and when the representative card information transmitted by the user terminal is invalid, the representative card registration determining unit 120 may transmit an error message to the user terminal.

In a case where the number of representative cards is plural, the representative card registration determining unit may transmit an error message of a corresponding card to the user terminal and may not register the corresponding card as the representative card when invalid card information is included in the plurality of elements of the representative card information.

As described above, only when the representative card information among the plurality of elements of the representative card information is valid, the corresponding card may be registered as the representative card.

The affiliated company selection information receiving unit 130 receives the selection information about the affiliated company, from which the user terminal is to receive the membership service through the representative card, among the plurality of affiliated companies providing the membership service, from the user terminal.

The affiliated company selection information receiving unit 130 may further include an affiliated company membership information transceiving unit (not illustrated).

The affiliated company membership information transceiving unit may receive affiliated company membership information for joining the affiliated company as a member corresponding to the affiliated company selection information from the user terminal, and may transmit the affiliated company membership information to the affiliated company server of the affiliated company.

For example, the user may transmit agreement information about “Terms/Personal information” of the affiliated company selected by himself/herself and membership information for joining the affiliated company as a member of the corresponding affiliated company to the membership service providing server 100 through the user terminal and simultaneously process a member joining procedure of the corresponding affiliated company. Accordingly, the user may join the affiliated company corresponding to the affiliated company selection information as the member, and receive the membership service of the corresponding affiliated company through a simple procedure.

The storing unit 140 matches and stores the user information, the affiliated company selection information, and the representative card information.

When the number of elements of the representative card information received in the representative card information registering unit 120 is plural, the storing unit 140 may batch and match, and store the user information, the affiliated company information according to the affiliated company selection information, and the plurality of elements of the representative card information. For example, when the plurality of representative cards is 1, 2, and 3, and affiliated companies from which the user is to receive the membership service are A, B, and C, cards 1, 2, 3 and affiliated companies A, B, and C may be matched with one another. That is, card 1 may be batched and matched with affiliated companies A, B, and C, card 2 may be batched and matched with affiliated companies A, B, and C, and card 3 may be batched and matched with affiliated companies A, B, and C to be stored.

In the meantime, when a single affiliated company, with which only one representative card may be matched, is included in the affiliated companies according to the affiliated company selection information, the single affiliated company may be matched with only any one representative card among the plurality of registered representative cards corresponding to the plurality of elements of the registered representative card information. For example, when the plurality of representative cards is 1, 2, and 3, affiliated companies selected as the affiliated companies from which the user terminal is to receive the membership service are A, B, and C, and affiliated company A is the single affiliated company with which only one single card may be matched, affiliated company A may be matched with only card 1 among cards 1, 2, and 3. That is, card 1 may be registered to affiliated company A, and cards 1, 2, and 3 may be registered to affiliated companies B and C.

In this case, card 1 may be the card set as the main representative card by the user or the membership service providing server 100 among the representative cards.

For example, when the user selects the representative card among his/her possessed cards, the user may select any one of the selected representative cards as the main representative card, and register the selected main representative card in the membership service providing server 100 together when registering the representative card information.

Further, the membership service providing server 100 may automatically set any one among the plurality of registered representative cards as the main representative card according to a card usage frequency order, a registration time order, and the like. The membership service providing server 100 may determine the mostly frequently used card among the plurality of representative cards registered as the representative cards, or the representative card earliest registered by the user among the plurality of representative cards as the main representative card.

In the meantime, whether the affiliated company is the single affiliated company may be confirmed through the affiliated company server in real time, or may be directly confirmed by the membership service providing server 100, which receives single affiliated company list information in advance and manages the received single affiliated company list information.

In the meantime, when the plurality of elements of representative card information and the affiliated company information according to the affiliated company selection information are batched and matched by the storing unit 140, the membership service providing server 100 may transmit matching result information between the plurality of representative cards and the affiliated companies to the user terminal, and the user terminal may display the received matching result information on a screen in a form of an SMS, a push message, a pop-up, and the like.

When the single affiliated company information is included in the affiliated company selection information, the membership service providing server 100 may also separately transmit matching result information, in which the main representative card is matched with the single affiliated company, to the user terminal.

As described in the above example, when affiliated company A is the single affiliated company so that card 1 is only matched with affiliated company A, the matching result information of card 1 and affiliated company A may be separately transmitted to the user terminal and a pop-up window may be displayed. In this case, the user may confirm that card 1 is matched with affiliated company A through the screen of the user terminal, and when the user desires to match affiliated company A, which is the single affiliated company, with another card, the user may select affiliated company A and another representative card through the user terminal, and transmit a change request for matching affiliated company A with another representative card to the membership service providing server 100.

For example, the user may perform change so that single affiliated company A is matched with card 2 through a process of confirming a matching result of card 1 and single affiliated company A in the pop-up window displayed on the user terminal, and then selecting a “change button” displayed on the pop-up window and selecting card 2.

As described above, in the present invention, the plurality of registered representative cards is batched and matched with one or more affiliated companies from which the user terminal desires to receive the membership service, so that it is possible to omit a complicated procedure of matching each card with several affiliated companies, and to match each card with the membership service for one or more affiliated companies at a time, thereby improving convenience of the user.

When the membership service providing unit 150 receives a membership service request through the representative card from the affiliated company server corresponding to the affiliated company selection information, the membership service providing unit 150 provides the corresponding user with the membership service, that is, at least one of mileage, a stamp, and a coupon. For example, when a user requests payment by using the membership service at the affiliated company selected by himself/herself through the representative card selected by the user, the user may save mileage provided by the affiliated company, or pay a part of settlement cost by using previously saved mileages, and when the user has a discount coupon, the user may pay a discounted cost by using the discount coupon.

When the number of registered representative cards is plural, and the user requests the payment at the affiliated company matched with the representative card through any one among the plurality of representative cards registered by the user, the affiliated company server corresponding to the affiliated company, at which the user requests the payment, may transmit the membership service request through any one representative card among the plurality of aforementioned representative cards to the membership service providing unit 150.

The membership service providing unit 150 may confirm whether the affiliated company information corresponding to the affiliated company server transmitting the membership service request is matched with the information about the representative card with which the payment request is made, and provide the user with at least one of mileage, a stamp, and a coupon provided by the corresponding affiliated company.

The membership service providing unit 150 may include a changed matter information providing unit (not illustrated) and a use detail information providing unit (not illustrated).

When a changed matter is generated in at least one of the mileage, the stamp, and the coupon provided to the user, the changed matter information providing unit may provide the user terminal with the changed matter information about the mileage, the stamp, or the coupon. That is, when a changed matter is generated by saving or using the mileage, the stamp, or the coupon by the user during the use of the membership service through the representative card at the affiliated company, the changed matter information providing unit may provide the user terminal with changed matter information about the mileage, the stamp, or the coupon according to the generation of the changed matter.

When the use detail information providing unit receives a use detail information transmission request of the membership service, that is, the mileage, the stamp, or the coupon, from the user terminal, the use detail information providing unit may provide the user terminal with use detail information about the mileage, the stamp, or the coupon of the user corresponding to the user information. For example, when the user requests the use detail information of about at least one of his/her saved mileage, the stamp, and the coupon on the web page linked with the membership service through the user terminal, the user may receive current status information about his/her saved mileages, stamps, or coupons, and the detail information of his/her saved mileages, stamps, or coupons.

In the meantime, the membership service providing unit 150 may be configured to provide another user terminal (not illustrated) with at least a part of the mileage, the stamp, and the coupon received by the user terminal 200 according to a request of the user terminal 200. That is, the user terminal 200 may request the membership service providing unit 150 to move and provide the mileage or the coupon of the user even to another user terminal in which an application of the present invention is installed, and the membership service providing unit 150 may be configured to move and provide the mileage or the coupon of the user.

Further, the membership service providing unit 150 may be configured to convert at least a part of mileage, a stamp, and a coupon of a predetermined affiliated company received by the user terminal 200 into mileage, a stamp, and a coupon of another affiliated company according to a request of the user terminal 200. That is, the membership service providing unit 150 may be configured so that mileage of affiliated company A is converted into mileage of affiliated company B according to a predetermined switch ratio.

Further, as described above, the membership service providing unit 150 may be configured to allow the conversion and saving of the mileage, the stamp, and the coupon while saving, as well as the conversion after saving the mileage, the stamp, and the coupon. More particularly, the membership service providing unit 150 may be configured to convert at least a part of mileage of a predetermined affiliated company received by the user terminal 200 into a stamp or a coupon and save the converted stamp or coupon according to a request of the user terminal 200. Similarly, the membership service providing unit 150 may be configured to convert at least a part of a stamp of a predetermined affiliated company into mileage or a coupon according to a request of the user terminal 200 and save the converted mileage or coupon, and the membership service providing unit 150 may be configured to convert a coupon of a predetermined affiliated company received by the user terminal 200 into mileage or a stamp and save the converted mileage or stamp according to a request of the user terminal 200.

On the other hand, the membership service providing unit 150 may be configured to provide mileage or the like when receiving a registration of information printed/attached to a product regardless of the use of the representative card, as well as to provide the membership service according to the use of the representative card. More particularly, the membership service providing unit 150 may be configured to provide the user terminal 200 with mileage, a stamp, or a coupon corresponding to registered information when the user terminal 200 registers information, which is obtained from at least one of a barcode, a QR code, a serial number, and an RFID printed or attached onto a product, in the membership service providing unit 150.

On the other hand, the membership service providing unit 150 may be configured so that when the membership service providing unit 150 inquires of the storing unit 140 and there is a user SNS account which is previously registered in connection with the user information, the user terminal 200 performs a pre-appointed activity, for example, an activity of promoting a specific affiliated company, on the SNS by using the SNS account, so that a least a part of mileage, a stamp, or a coupon provided by the predetermined affiliated company is saved. Here, the activity of the promotion may include an activity of forwarding an advertisement or an event of the specific affiliated company through the SNS, writing a comment for an advertisement or an event of the specific affiliated company, and the like.

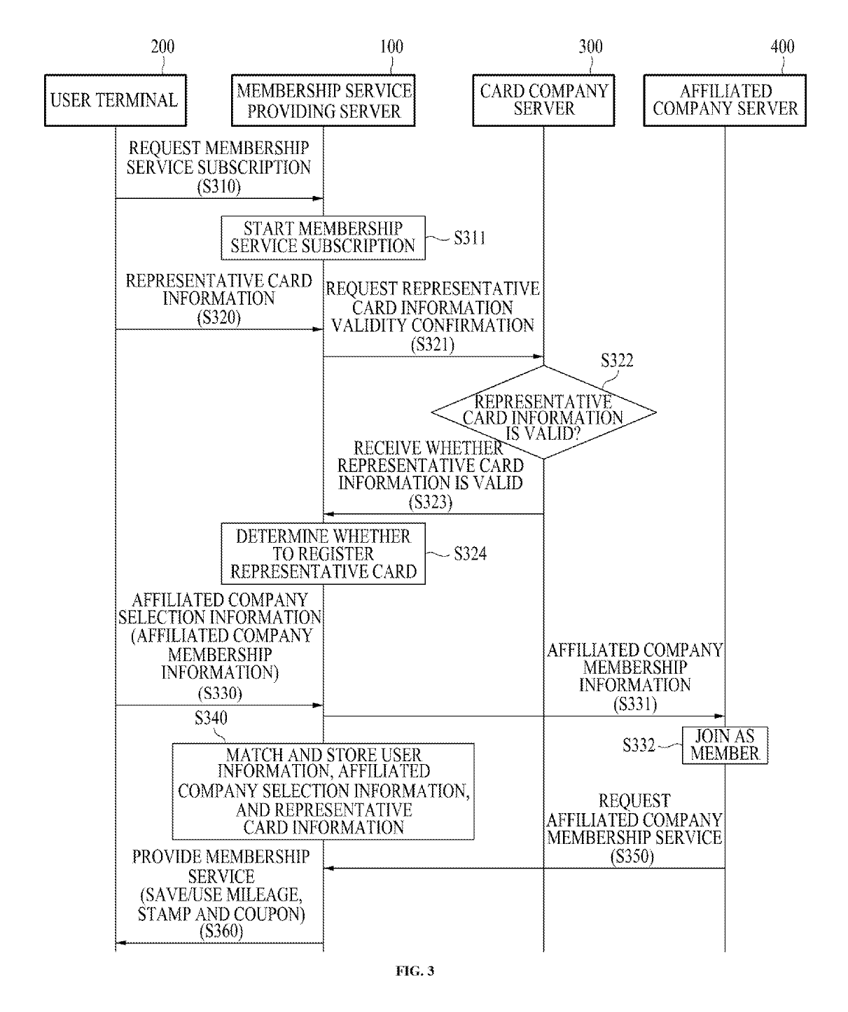

FIG. 3 is a flowchart illustrating a membership service providing method according to another exemplary embodiment of the present invention.

When the membership service providing server 100 receives a membership service subscription request including user information from the user terminal 200 (S310), a membership service subscription procedure may be started (S311).

The membership service providing server 100 receives information about a representative card to be used for a membership service from the user terminal 200 (S320), and makes a request for confirming whether representative card information is valid from the card company server 300 corresponding to the received information of the representative card (S321). In this case, the representative card information may include a card number, card company information, a CVC number, and the like.

In this case, in a case where the number of representative cards is plural, the membership service providing server 100 may receive a plurality of elements of the representative card information from the user terminal 200 (S320), and make a request for confirming whether the representative card information is valid for each of the card company servers 300 corresponding to the plurality of elements of the representative card information (S321).

The card company server 300 determines whether the representative card information is valid (S322). For example, the card company server 300 may determine whether the representative card information is valid, by comparing the representative card information including the unique card number and card information stored in the card company server, and confirming whether a user is matched, the unique card number is valid, and the like.

Then, the card company server 300 transmits information indicating whether the representative card information is valid, to the membership service providing server 100 (S323).

The membership service providing server 100 receiving the information indicating whether the representative card information is valid determines whether to register the representative card according to whether the representative card information is valid(S324). That is, when the representative card information is valid, the membership service providing server 100 registers the card as a representative card, and when the representative card information is invalid, the membership service providing server 100 does not register the card as a representative card.

In a case where the number of elements of the representative card information is plural, the membership service providing server 100 receives whether each element of the representative card information is valid, from each card company server 300, and registers the card having the valid representative card information as the representative card, but does not register the card having invalid representative card information. In this case, when the representative card information is invalid, the membership service providing server 100 may transmit an error message to the user terminal 200.

The user terminal 200 selects an affiliated company, from which the user terminal desires to receive the membership service through the representative card, among a plurality of affiliated companies providing the membership service, and transmits affiliated company selection information to the membership service providing server 100 (S330).

In this case, the user terminal 200 may transmit affiliated company membership information for joining the affiliated company corresponding to the affiliated company selection information as a member together with the affiliated company selection information. For example, the user terminal 200 may transmit “Terms/Personal Information” agreement information of the corresponding affiliated company and membership information for joining the affiliated company as a member of the corresponding affiliated company to the membership service providing server 100 and simultaneously process a member joining procedure of the corresponding affiliated company.

The membership service providing server 100 may transmit the affiliated company membership information received from the user terminal 200 to the affiliated company server 400 of the corresponding affiliated company (S331).

The affiliated company server 400 may allow the corresponding user to join the affiliated company as a member based on the received affiliated company membership information (S332).

Then, the membership service providing server 100 matches and stores the user information, the affiliated company selection information, and the representative card information (340).

The membership service providing server 100 may batch and match and store the user information, the affiliated company information according to the affiliated company selection information, and the plurality of elements of the representative card information. When a single affiliated company, with which only one representative card may be matched, is included in the affiliated companies according to the affiliated company selection information, single affiliated company information may be matched with only any one representative card information among the plurality of elements of the representative card information.

In this case, the representative card matched with the single affiliated company may be a main representative card selected by the user in advance or the membership service providing server 100 may select any one of the plurality of representative cards as a main representative card, and match the main representative card with the single affiliated company information.

The membership service providing server 100 may transmit matching result information in which the user information, the representative card information, and the affiliated company selection information are matched to the user terminal 200.

When the membership service providing server 100 receives a membership service request through the representative card from the affiliated company server 400 of the affiliated company corresponding to the affiliated company selection information (S350), the membership service providing server 100 provides the corresponding user with at least one of mileage, a stamp, and a coupon (S360).

When the number of representative cards registered by the user is plural and a payment request is made at the affiliated company matched with any one representative card through the one representative card among the plurality of representative cards, the membership service providing server 100 may receive the membership service request from the affiliated company server corresponding to the affiliated company, at which the user requests the payment, confirm whether the affiliated company information corresponding to the corresponding affiliated company server is matched with the representative card information with which the payment request is made, and then provide the user with at least one of the mileage, the stamp, and the coupon provided by the corresponding affiliated company (S360).

The membership service providing server 100 may provide the user terminal 200 with changed matter information or use detail information about the mileage, the stamp, or the coupon. Particularly, when a changed matter is generated in at least one of the mileage, the stamp, and the coupon provided to the user, the membership service providing server 100 may transmit the changed matter information about the mileage, the stamp, or the coupon to the user terminal 200. Further, when the membership service providing server 100 receives a use detail information transmission request of the mileage, the stamp, or the coupon from the user terminal 200, the membership service providing server 100 may provide the user terminal with the use detail information about the mileage, the stamp, or the coupon of the user corresponding to the corresponding user information.

In the meantime, the membership service providing server 100 may be configured to provide another user terminal (not illustrated) with at least a part of the mileage, the stamp, and the coupon received by the user terminal 200 according to a request of the user terminal 200. That is, the user terminal 200 may make a request for moving and providing the mileage, the stamp, or the coupon of the user to another user terminal in which an application of the present invention is installed. If necessary, it is possible for one person to use the coupon or the mileage by collecting the coupon or the mileage of another people when making a payment.

Further, the membership service providing server 100 may be configured to convert at least a part of mileage, a stamp, and a coupon of a predetermined affiliated company received by the user terminal 200 into mileage, a stamp, or a coupon of another affiliated company according to a request of the user terminal 200. That is, the membership service providing server 100 may be configured to convert mileage of affiliated company A into mileage of affiliated company B according to a predetermined conversion ratio. Mileage of an unnecessary affiliated company is converted to mileage of an affiliated company desired by the user, thereby improving a utility ratio of the mileage.

Further, as described above, the membership service providing server 100 may be configured to allow the conversion and saving of the mileage, the stamp, and the coupon during the saving, as well as the conversion after the saving of the mileage, the stamp, and the coupon. More particularly, the membership service providing server 100 may be configured to convert at least a part of mileage of a predetermined affiliated company received by the user terminal 200 into a stamp or a coupon and save the converted stamp or coupon according to a request of the user terminal 200. Similarly, the membership service providing unit 150 may be configured to convert at least a part of a stamp of a predetermined affiliated company into mileage or a coupon according to a request of the user terminal 200 and save the converted mileage or coupon, and the membership service providing unit 150 may be configured to convert a coupon of a predetermined affiliated company received by the user terminal 200 into mileage or a stamp and save the converted mileage or stamp according to a request of the user terminal 200.

On the other hand, the membership service providing server 100 may be configured to provide mileage or the like when receiving a registration of information printed/attached to a product regardless of the use of the representative card, as well as to provide the membership service according to the use of the representative card. More particularly, the membership service providing server 100 may be configured to provide the user terminal 200 with mileage, a stamp, or a coupon corresponding to registered information when the user terminal 200 registers information, which is obtained from at least one of a barcode, a QR code, a serial number, and an RFID printed or attached onto a product, in the membership service providing server 100.

On the other hand, the membership service providing server 100 may be configured so that when there is a user SNS account previously registered in connection with the user information, and the user terminal 200 performs a pre-appointed activity, for example, an activity of promoting a specific affiliated company, on the SNS by using the SNS account, a least a part of mileage, a stamp, or a coupon provided by the predetermined affiliated company is saved. Here, the activity of the promotion may include an activity of forwarding an advertisement or an event of the specific affiliated company through the SNS, writing a comment for an advertisement or an event of the specific affiliated company, and the like.

The franchise POS terminal 600 may be configured to designate a sound source output through a speaker at the franchise. The franchise POS terminal 600 may be configured to add a predetermined advertisement (AD) code to a sound source and output the sound source by sound waves through the speaker.

Because the sound waves may not pass through a wall, it is possible to receive electric waves only within the franchise, and the AD code added to the sound waves is not recognized by users.

The AD code is configured so that the user terminal 200 may request the affiliated company selection information and at least one of the mileage, the stamp, and the coupon of the affiliated company selection information from the membership service providing server 100.

The user terminal 200 detects the sound waves of the speaker and recognizes the AD code in the detected sound waves. An application for recognizing the AD code and implementing a corresponding operation may be included in the user terminal 200 in advance.

The user terminal 200 may be configured to recognize the affiliated company selection information in connection with a corresponding franchise through the recognized AD code, and determines whether the recognized affiliated company selection information is already registered in the user terminal 200.

As a result of the determination, when the recognized affiliated company selection information is not registered, the user terminal 200 may be configured to request the affiliated company selection information from the membership service providing server 100 and receive the requested affiliated company selection information from the membership service providing server 100, and match the received affiliated company selection information with the user information and the representative card information and register the matched affiliated company selection information and representative card information.

Further, the user terminal 200 may be configured to save at least one of the mileage, the stamp, and the coupon of the corresponding affiliated company through the membership service request through the representative card.

In the meantime, as the result of the determination, when the recognized affiliated company selection information is registered, the user terminal 200 may be configured to as to request at least one of the mileage, the stamp, and the coupon of the corresponding affiliated company provided through the AD code from the membership service providing server 100 and receive the requested one from the membership service providing server 100.

Further, the user terminal 200 may be configured to save the received mileage, stamp, or coupon, or use at least one of the saved mileage, stamp, and coupon for the payment through the representative card.

In this case, the user terminal may directly request registering/storing the affiliated company selection information to/in the membership service providing server 100 through a push message, and immediately save the coupon, the mileage, or the stamp of the affiliated company when making a payment at the corresponding franchise. It is very useful to immediately register/store and use the affiliated company selection information which has not been previously registered/stored, and it is possible to automatically register/store franchise company selection information and save/use mileage, a stamp, or a coupon of the corresponding franchise even though the user is not aware of the affiliated company selection information about the corresponding affiliated company.

According to the present invention, a user registers one of pre-possessed cards for using the membership service as a representative card, thereby conveniently receiving membership services of various affiliated companies. Further, a user does not need to be issued with a separate card for receiving the membership service, so that a card company may decrease a card preparing expense.

In the meantime, the membership service providing server 100 allows a user to select an affiliated company from which the user terminal is to receive a membership service, so that all of the membership services for the affiliated companies providing the membership services are not batched and provided, but it is possible to provide an individualized and optimized membership service for each user.

Further, the plurality of elements of the representative card information is simply batched and matched with one or more affiliated company selection information and registered without a complicated procedure of matching the cards and the affiliated companies one by one and registering the matched cards and affiliated companies, thereby providing convenience.

Although the present invention has been described with reference to the exemplary embodiments, those skilled in the art may understand that the present invention may be variously modified and changed within a scope without departing from the spirit and the area of the present invention described in the accompanying claims.

1. A method of providing a membership service by a membership service providing server connected with a user terminal, the method comprising:
a) receiving a membership service subscription request including user information from the user terminal;
b) receiving representative card information about a representative card used for the membership service from the user terminal and registering the representative card information;
c) receiving affiliated company selection information about an affiliated company, from which the user terminal is to receive the membership service through the representative card, among a plurality of affiliated companies providing the membership service from the user terminal;
d) matching and storing the user information, the affiliated company selection information, and the representative card information; and
e) providing the user terminal according to the user information with at least one of mileage, a stamp, and a coupon provided by the affiliated company when receiving a membership service request through the representative card from an affiliated company server corresponding to the affiliated company selection information,
wherein in step e) of providing the user terminal according to the user information with at least one of the mileage, the stamp, and the coupon provided by the affiliated company when receiving the membership service request through the representative card from the affiliated company server corresponding to the affiliated company selection information, at least one of the mileage, the stamp, and the coupon of the affiliated company matched with the corresponding representative card information is saved or a previously saved mileage, stamp, or coupon is used for payment when making the payment using the representative card.

2. The method of claim 1, wherein step b) includes:
receiving the representative card information from the user terminal;
receiving whether the representative card information is valid from a card company server corresponding to the representative card information; and
determining whether to register the representative card according to whether the representative card information is valid.

3. The method of claim 1, wherein step c) includes:
receiving affiliated company membership information for joining the affiliated company corresponding to the affiliated company selection information as a member from the user terminal; and
transmitting the affiliated company membership information to the affiliated company server.

4. The method of claim 1, further comprising:
providing with the user terminal with changed matter information about the mileage, the stamp, or the coupon when a changed matter is generated in at least one of the mileage, the stamp, and the coupon provided to the user terminal.

5. The method of claim 1, further comprising:
receiving a use detail information transmission request of the mileage, the stamp, or the coupon from the user terminal; and
providing the user information with the user terminal with use detail information about the mileage, the stamp, or the coupon of a user corresponding.

6. The method of claim 1, further comprising:
providing another user terminal with at least a part of the mileage, the stamp, and the coupon received by the user terminal according to a request of the user terminal.

7. The method of claim 1, further comprising:
converting at least a part of mileage, a stamp, and a coupon of a predetermined affiliated company received by the user terminal into mileage, a stamp, or a coupon of another affiliated company according to a request of the user terminal.

8. The method of claim 1, further comprising:
converting at least a part of mileage of a predetermined affiliated company received by the user terminal into a stamp or a coupon and saving the converted stamp or coupon according to a request of the user terminal, converting a stamp of a predetermined affiliated company received by the user terminal into mileage or a coupon and saving the converted mileage or coupon according to a request of the user terminal, or converting a coupon of a predetermined affiliated company received by the user terminal into mileage or a stamp and saving the converted mileage or stamp according to a request of the user terminal.

9. The method of claim 1, further comprising:
providing the user terminal with mileage, a stamp, or a coupon corresponding to registered information when the user terminal registers information, which is obtained from at least one of a barcode, a QR code, a serial number, and an RFID printed or attached onto a product, in the membership service providing server.

10. The method of claim 1, further comprising:
saving at least a part of mileage, a stamp, and a coupon provided by a predetermined affiliated company according to a predetermined activity of a user's SNS account which is previously registered in connection with the user information.

11. A method of providing a membership service, comprising:
adding, by a franchise POS terminal, an advertisement code (AD code) to a sound source and outputting the sound source as sound waves through a speaker;
detecting, by a user terminal, the output sound waves and recognizing the AD code in the detected sound waves;
recognizing, by the user terminal, affiliated company selection information in connection with a corresponding franchise through the recognized AD code, and determining whether the recognized affiliated company selection information is registered;
in a case where the recognized affiliated company selection information is not registered, requesting, by the user terminal, the affiliated company selection information to a membership service providing server and receiving the requested affiliated company selection information, matching the received affiliated company selection information with user information and representative card information and registering the matched information, and saving at least one of mileage, a stamp, and a coupon of a corresponding affiliated company through a membership service request with a representative card; and
in a case where the recognized affiliated company selection information is registered as a result of the determination, requesting, by the user terminal, at least one of mileage, a stamp, and a coupon of a corresponding affiliated company provided through the AD code from the membership service providing server and receiving at least one of the mileage, the stamp, and the coupon of the corresponding affiliated company, and saving the received mileage, stamp, or coupon, or using at least one of a saved mileage, stamp, and coupon for payment with the representative card.

12. A method of providing a membership service by a membership service providing server connected with a user terminal, the method comprising:
a) receiving a membership service subscription request including user information from the user terminal;
b) receiving representative card information about a representative card used for the membership service from the user terminal and registering the representative card information;
c) receiving affiliated company selection information about an affiliated company, from which the user terminal is to receive the membership service through the representative card, among a plurality of affiliated companies providing the membership service, from the user terminal;
d) matching and storing the user information, the affiliated company selection information, and the representative card information; and
e) when receiving a membership service request through the representative card from an affiliated company server corresponding to the affiliated company selection information, providing a user according to the user information with at least one of mileage, a stamp, and a coupon provided by the affiliated company,
wherein the number of representative cards is plural.

13. The method of claim 12, wherein step d) includes batching and matching the user information, affiliated company information according to the affiliated company selection information, and information about the plurality of representative cards and storing the matched information.

14. The method of claim 13, wherein step e) includes:
when receiving a membership service request through any one representative card among the plurality of representative cards from the affiliated company server, confirming whether the representative card requesting the membership service is matched with an affiliated company corresponding to the affiliated company server; and
providing the user with at least one of mileage, a stamp, and a coupon provided by the affiliated company when the representative card requesting the membership service is matched with the affiliated company as a result of the confirmation.

15. The method of claim 14, wherein the providing of the user with at least one of the mileage, the stamp, and the coupon provided by the affiliated company when the representative card requesting the membership service is matched with the affiliated company as the result of the confirmation includes saving at least one of the mileage, the stamp, and the coupon of the affiliated company matched with the corresponding representative card information, or using a previously saved mileage, stamp, or coupon for a payment when making the payment using the representative card.

16. The method of claim 14, wherein in the batching and matching of the affiliated company information according to the affiliated company selection information with the information about the plurality of representative cards and storing the matched information, when a single affiliated company matched with only one representative card is included in affiliated companies according to the affiliated company selection information, information about the single affiliated company is matched with the user information and representative card information about any one representative card among the plurality of representative cards.

17. The method of claim 16, wherein any one of the plurality of representative cards is determined according to main representative card selection information received through the user terminal.

18. The method of claim 12, further comprising:
providing another user terminal with at least a part of the mileage, the stamp, and the coupon received by the user terminal according to a request of the user terminal.

19. The method of claim 12, further comprising:
converting at least a part of mileage, a stamp, and a coupon of a predetermined affiliated company received by the user terminal into mileage, a stamp, or a coupon of another affiliated company according to a request of the user terminal.

20. The method of claim 12, further comprising:
converting at least a part of mileage of a predetermined affiliated company received by the user terminal into a stamp or a coupon and saving the converted stamp or coupon according to a request of the user terminal, converting a stamp of a predetermined affiliated company received by the user terminal into mileage or a coupon and saving the converted mileage or coupon according to a request of the user terminal, or converting a coupon of a predetermined affiliated company received by the user terminal into mileage or a stamp and saving the converted mileage or stamp according to a request of the user terminal.

21. The method of claim 12, further comprising:
providing the user terminal with mileage, a stamp, or a coupon corresponding to registered information when the user terminal registers information, which is obtained from at least one of a barcode, a QR code, a serial number, and an RFID printed or attached onto a product, in the membership service providing server.

22. The method of claim 12, further comprising:
saving at least a part of mileage, a stamp, and a coupon provided by a predetermined affiliated company according to a predetermined activity of a user's SNS account which is previously registered in connection with the user information.

23. A method of providing a membership service, comprising:
adding, by a franchise POS terminal, an advertisement code (AD code) to a sound source and outputting the sound source as sound waves through a speaker;
detecting, by a user terminal, the output sound waves and recognizing the AD code in the detected sound waves;
recognizing, by the user terminal, affiliated company selection information in connection with a corresponding franchise through the recognized AD code, and determining whether the recognized affiliated company selection information is registered;
in a case where the recognized affiliated company selection information is not registered, requesting, by the user terminal, the affiliated company selection information to a membership service providing server and receiving the requested affiliated company selection information, matching the received affiliated company selection information with user information and representative card information and registering the matched information, and saving at least one of mileage, a stamp, and a coupon of a corresponding affiliated company through a membership service request with a representative card; and
in a case where the recognized affiliated company selection information is registered as a result of the determination, requesting, by the user terminal, at least one of mileage, a stamp, and a coupon of a corresponding affiliated company provided through the AD code from the membership service providing server and receiving at least one of the mileage, the stamp, and the coupon of the corresponding affiliated company, and saving the received mileage, stamp, or coupon, or using at least one of a saved mileage, stamp, and coupon for payment with the representative card,
wherein the number of representative cards is plural.

24. A computer readable recoding medium in which a program for executing the method according to claim 1 is recorded.

25-49. (canceled)
